(19) United States
(12) Patent Application Publication
(10) Pub. No.: US 2025/0083413 A1
(43) Pub. Date: Mar. 13, 2025

(54) STAINLESS STEEL POLYMER ADHESION LAYER

(71) Applicant: Apple Inc., Cupertino, CA (US)

(72) Inventors: Todd S. Mintz, San Jose, CA (US); Kar-Wai Hon, HsinChu (TW); James A. Curran, Sunnyvale, CA (US); Daniel T. McDonald, San Jose, CA (US)

(21) Appl. No.: 18/588,511

(22) Filed: Feb. 27, 2024

Related U.S. Application Data
(60) Provisional application No. 63/581,173, filed on Sep. 7, 2023.

(51) Int. Cl. B32B 15/09; B32B 15/18; B32B 27/36; C23F 1/40; C25F 3/06

(52) U.S. Cl. CPC B32B 15/09; B32B 15/18; B32B 27/36; C23F 1/40; C25F 3/06

(57) ABSTRACT

A chemical treatment process has been identified as a simple and effective means of improving the bonding of injection-molded polymer to stainless steel surfaces. This process forms an oxide layer on a stainless steel surface that includes a layered double hydroxide. The layered double hydroxide both raises the bond strength and minimizes air or water leakage. The process enables the use of stainless steel alloys with injection molded polymer structural bonds in strong, lightweight, and water-resistant enclosures for consumer electronics.

### CROSS-REFERENCE TO RELATED APPLICATION(S)

This claims priority to U.S. Provisional Patent Application No. 63/581,173, filed 7 Sep. 2023, and entitled “Stainless Steel Polymer Adhesion Layer,” the entire disclosure of which is hereby incorporated by reference in its entirety.

### FIELD

The described embodiments relate generally to surface structures on a stainless steel surface. More particularly, the present embodiments relate to systems and methods for forming interlocking structures at a stainless steel surface for attaching a polymer material to the stainless steel surface.

### BACKGROUND

Enclosures for consumer devices are typically constructed from a combination of metal and non-metal materials in order to provide functional, structural, and cosmetic enhancements. However, metals that exhibit characteristics favorable for use in consumer devices, such as stainless steel, may lack a natural ability to attach to these non-metal materials. Techniques for modifying the metal in order to facilitate attachment to the non-metal material can demand a considerable amount of time, expense, and effort. Furthermore, despite being able to attach the non-metal material to the metal material, these techniques may be unable to provide an acceptable amount of pull strength between the stainless steel and the non-metal material.

### SUMMARY

Various embodiments that relate to an oxide developed on a stainless steel surface are disclosed. Further, embodiments that relate to techniques for etching a surface of a metal part that includes stainless steel. In particular, the various embodiments relate to systems and methods for forming interlocking structures at an oxide surface of the stainless steel part for attaching a polymer material to the surface of a metal part that includes a stainless steel substrate.

According to some embodiments, an oxide layer on a stainless steel substrate can include a layered double hydroxide. In some examples, the oxide layer can include an iron-rich precipitate deposited on a porous iron-nickel layer. In some examples, the oxide layer can include a thickness of about 100 nm to about 300 nm. The oxide layer can include a porosity between about 30% and about 80%, in some examples. In some examples, the iron-rich precipitate can include a microstructure including a spheroidal structure having a diameter between about 20 nm and about 100 nm. In some examples, the oxide layer can include a first layer including an iron-nickel hydroxide layer having a thickness between about 80 nm and about 150 nm, and a second layer including an iron-rich oxide disposed over the first layer, the second layer including spheroidal structures having a diameter between about 20 nm and about 100 nm. The oxide layer can further include a porous structure defining a pore having a diameter between about 20 nm and about 50 nm.

According to some embodiments, a stainless steel-polymer interface can include an oxide layer on a stainless steel substrate and a polymer. In some examples, the polymer permeates the oxide layer and can form a bond having a bond strength of about 25 MPa or greater. In some embodiments, the oxide layer can include a layered double hydroxide. In some examples, the polymer can include at least one of a glass-filled PBT resin, a polyamide, and an epoxy.

In some examples, the oxide layer can include a surface roughness greater than about 500 nm Sz. In some examples, the oxide layer can include an iron-rich precipitate deposited on a porous iron-nickel layer. In some examples, the polymer can include an injection-molded polymer. In some examples, the stainless steel-polymer interface can include a polymer having a dynamic viscosity between about 800 P·s and about 200 Pa·s.

According to some embodiments, a method of forming an oxide layer on a stainless steel substrate can include immersing the stainless steel substrate in a caustic solution and applying a cathodic potential between the stainless steel substrate and an anode. In some examples, the caustic solution can include a solution between about 1 molar and about 10 molar sodium hydroxide or potassium hydroxide. In some examples, the cathodic potential can include a pulsed potential comprising a voltage between about 2 V and about 5V and a pulse rate of between about 1 minute and about 4 minutes energized and about 1 minute and about 4 minutes de-energized, the pulse repeated between about 2 times and about 20 times. In some examples, the caustic solution is between about 50° C. and about 90° C. A ratio between the anode and the stainless steel substrate can be between about 2:1 and about 10:1. In some examples, the method can form an oxide layer having a surface roughness between about 500 nm and about 1000 nm Sz.

Other aspects and advantages of the disclosure will become apparent from the following descriptions taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates perspective views of various electronic devices having metal surfaces that can be processed using the techniques described herein, in accordance with some embodiments.

FIG. 2 illustrates an exploded view of a component of an electronic device.

FIG. 3A exemplary images of views of a stainless steel substrate having an oxide layer developed using the techniques described herein, in accordance with some embodiments.

FIG. 3B illustrates a cross sectional view of a stainless steel substrate including an oxide layer at the surface developed using the techniques described herein, in accordance with some embodiments.

FIGS. 4A-4D illustrate scanning electron microscope images of cross-sections of exemplary stainless steel substrates having an oxide layer developed using the techniques described herein, in accordance with some embodiments.

FIG. 5 illustrates a method of forming a layered double hydroxide oxide layer on a stainless steel substrate, according to some embodiments.

FIG. 6A illustrates a diagram of a stainless steel-polymer interface and the bond strength of the interface, in accordance with some embodiments.

FIG. 6B illustrates a graph indicating a relationship of the pull strength between etching treatment processes and pull strength of a treated metal part, in accordance with some examples.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a chemical treatment process that provides an effective means of improving the bonding of polymers to stainless steel surfaces. Stainless steel is an attractive metal for certain engineering applications due to its high resistance to corrosion and aesthetic appeal. For example, this allows corrosion resistant and relatively inexpensive enclosures for portable electronic devices. In any such applications, bonding to other materials such as polymers, glass, ceramics is desirable. In particular, injection-molded polymers can be used to electrically isolate various parts of an enclosure, whilst ideally maintaining structural strength. Examples of chemical processes for producing a thin, rough, surface oxide on a stainless steel substrate, that greatly improve the adhesion of polymers to the substrate are provided herein.

In a particular embodiment, once the final geometry of the stainless steel substrate has been prepared for adhesive bonding, the stainless steel can be optionally etched to raise its roughness. After etching, a chemical process described in more detail below, a surface structure can be produced on the stainless steel substrate or surface to which a structural polymer, such as glass-filled ABS, can be injection molded with a resulting bond strength high enough to endure wear and tear while exhibiting a low rate of air leakage through the bond in leak testing.

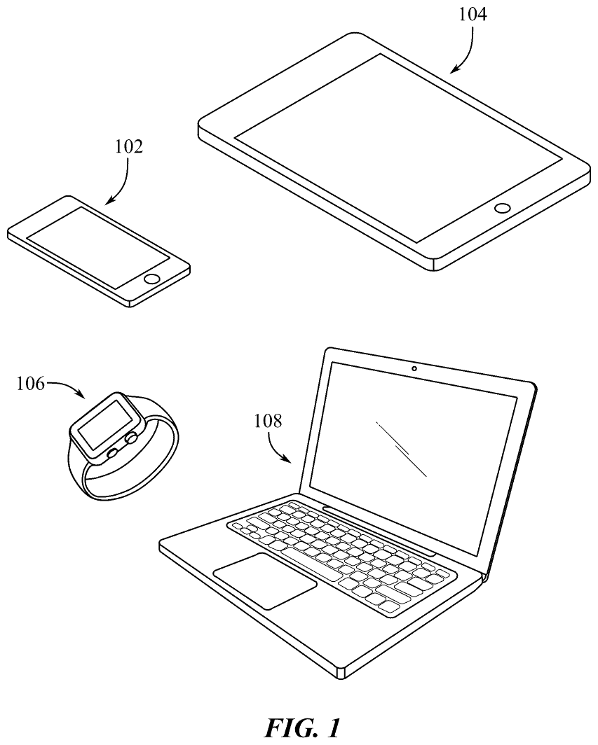

These and other embodiments are discussed below with reference to FIGS. 1-6B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

Stainless steel is frequently cited as a material of choice for consumer—grade portable electronic devices. Stainless steel has desirable attributes such as high specific strength and stiffness, and is relatively easy to machine. Stainless steel is a corrosion-resistant alloy of iron, chromium and nickel, and in some instances, other metals. Completely and infinitely recyclable, stainless steel is the “green material” par excellence. Stainless steel can also be used in combination with non-metal materials, such as glass and polymer. For instance, displays of portable electronic devices can be bonded to a stainless steel frame for the enclosure. The stainless steel frame is often sub-divided into various electrically isolated parts such as to prevent electromagnetic interference of antenna(s) carried within the enclosure. For example, stainless steel can be used to form a structural band around the edges of the enclosure such that the display is bonded to one face, and glass is bound to the opposing face. Furthermore, electrical insulating splits may be formed about the perimeter of the enclosure.

In order for the structural band to impart the enclosure with sufficient structural strength, robustness, rigidity, and heat and moisture-resistance throughout its lifetime, the enclosure demands a strong adhesive bond to be formed between the metal (e.g., stainless steel) and the non-metal material (e.g., polymer). These requirements can be even more technically challenging to satisfy in the face of additional insulating splits (for improved antenna performance) and even smaller areas of adhesion (to minimize weight and space). Moreover, the increasing need for water resistant enclosures demands that these adhesive bonds not only maintain strength, but also prevent moisture leakage even after the enclosure has been subjected to many strain cycles. Furthermore, conventional mechanisms for fastening metal to non-metal material such as mechanical fasteners (e.g., riveters) cannot typically be used in portable electronic devices because it can eliminate electrical isolation between metal parts. For example, a non-metal material (e.g., polymer) is used to electrically isolate different metal parts that are attached together. Furthermore, alternative methods for forming polymer adhering features, such as micro-arc oxidation or by anodizing in fluoride-based electrolytes or caustic solutions, yield generally poor adhesive performance. Indeed, these processes generate lightly scalloped structures that fail to provide sufficient attachment strength, water-resistance, and pull strength demanded by portable electronic devices that undergo consumer usage in harsh environments.

As enclosures for portable electronic devices become smaller and/or the design of these enclosures changes to a mere peripheral band of metal, the area allowed for bonding between metal and non-metal is greatly reduced. Thus, there is an increased emphasis in more robust metal to non-metal bonding.

As used herein, the terms oxide coating, oxidized layer, oxide layer, oxide film, oxidized layer, porous oxide layer, and surface oxide layer can be used interchangeably and can refer to any appropriate oxide layers. The oxide layers are formed on surfaces of a stainless steel substrate. In some embodiments, the non-metal layer can include a majority of non-metal materials that are mixed or in combination with metal materials such that the non-metal layer is largely made of non-metal materials. As used herein, the terms part, layer, segment, and section can also be used interchangeably where appropriate.

These and other embodiments are discussed below with reference to FIGS. 1-6B. However, those skilled in the art will readily appreciate that the detailed description given herein with respect to these figures is for explanatory purposes only and should not be construed as limiting.

FIG. 1 illustrates various portable electronic devices that can be processed using the techniques described herein. The techniques as described herein can be used to process metallic surfaces (e.g., stainless steel oxide layers, etc.) of enclosures of portable devices for consumer usage. FIG. 1 illustrates a smartphone 102, a tablet computer 104, a smartwatch 106, and a portable computer 108. According to some embodiments, the metallic surfaces can refer to a metal substrate overlaid by a metal oxide layer. In some examples, the metal oxide layer can be formed from the metal substrate. In particular, the metal oxide layer can function as an additional protective coating to protect the metal substrate, for example, when these portable devices are dropped, scratched, chipped, or abraded.

According to some embodiments, a non-metal material can be attached to the external surface of the metallic surface. In particular, the multi-layer enclosures of these portable devices that include a combination of metal and non-metal materials can provide improved structural and electromagnetic interference reduction benefits to the functionality of these portable devices. In one example, these portable devices can include a wireless antenna/transceiver that is capable of receiving and transmitting data signals with other electronic devices. However, a metal surface that directly covers the wireless antenna can cause an amount of undesirable electromagnetic interference that can affect the ability of the portable device to receive and/or transmit data signals. A non-metal material, such as a polymer, is generally non-electrically conductive (i.e., dielectric), and thus can minimize the amount of electromagnetic interference that affects the portable device while still imparting the enclosure of the portable device with a sufficient amount of structural rigidity and protective qualities.

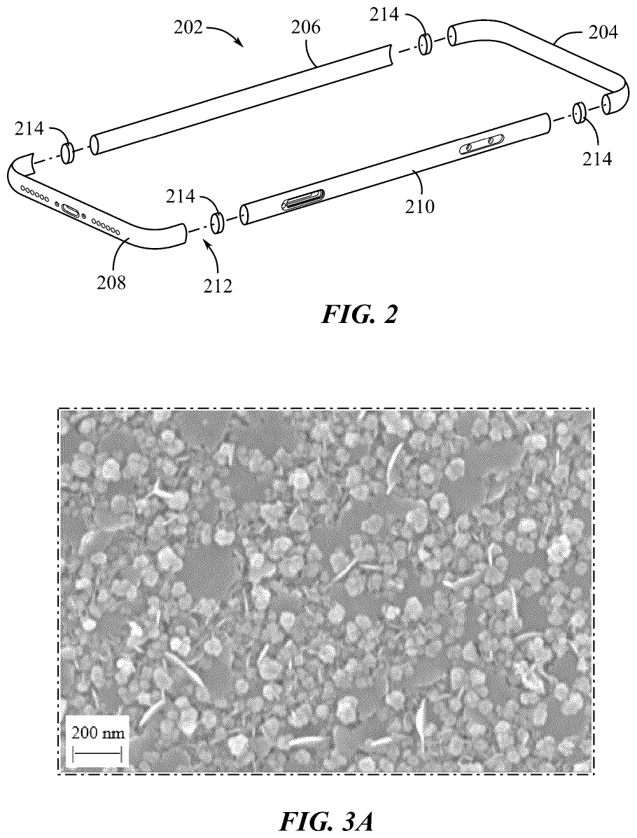

FIG. 2 illustrates an exploded view of a band 202 that can form part of a housing or an enclosure of an electronic device, such as electronic devices 102-108 described in FIG. 1. The band 202 can include one or more portions that are stainless steel components, such as an exterior portion joined to an interior portion, as described herein. For example, the band 202 can include a first stainless steel sidewall component 204, a second stainless steel sidewall component 206, a third stainless steel sidewall component 208 (opposite the first composite sidewall component 204), and a fourth stainless steel sidewall component 210. In some examples, as described herein, the stainless steel components 204, 206, 208, 210 can be separated and/or joined together by a material that can include an electrically inert or insulated material, such as polymer and/or resin, as a non-limiting example.

Although the embodiment illustrated in FIG. 2 includes a band 202 having multiple stainless steel components 204, 206, 208, 210 that are joined together, in some embodiments, a housing or enclosure for an electronic device can include or can be formed from a single stainless steel component having an interior and exterior portion, as described herein. Further, in some examples, the stainless steel components can form portions of the housing or enclosure other than the sidewalls, such as a top portion, a bottom portion, or any other portion of the housing or enclosure. The stainless steel components 204, 206, 208, 210 of the band 202 can be formed by a variety of processes and can allow for the band 202 to have a detailed shape or design that is tailored specifically to satisfy one or more needs, such as internal dimensional requirements, without the need for additional features to reinforce the structure of the band.

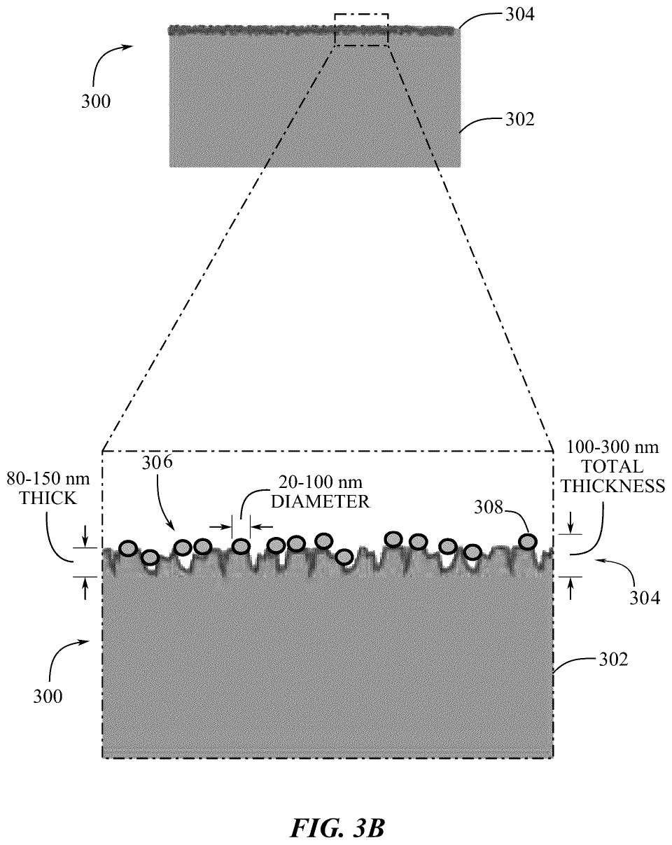

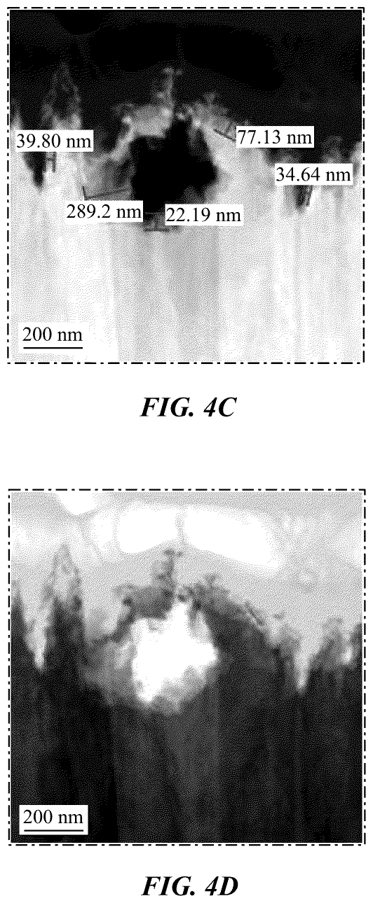

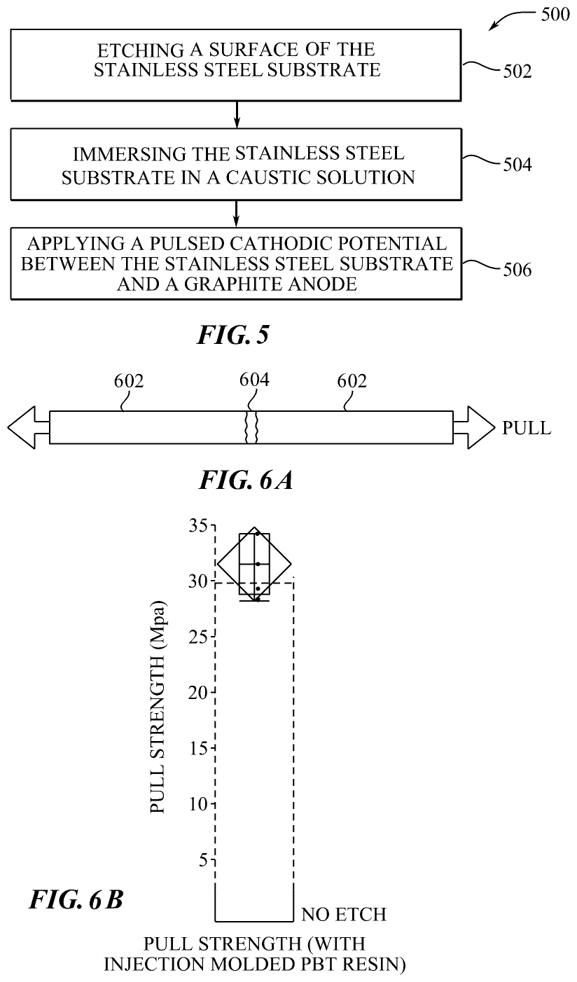

Openings, or split regions can separate adjacent stainless steel components of the band 202. For example, the sidewall component 208 is separated from the sidewall component 210 by an opening 212. The sidewall component 208 is separated from the sidewall component 206 by an additional opening. A non-metal spacer 214 can fill each of the openings. In some examples, the non-metal spacer 214 can include a polymer. The polymer can, according to some examples, be at least one of an injection molded glass-filled PBT resin, a polyamide, and an epoxy. In some examples, the polymer can be bonded to the stainless steel component with stainless steel-polymer bonding operations. Further details of the stainless steel components and exemplary methods to improve the bonding strength of the stainless steel-polymer bond are provided below with reference to FIGS. 5A-6B. Additionally, further details of an exemplary oxide layer disposed on the surface of a stainless steel substrate are provided below with reference to FIG. 3A.

FIG. 3A illustrates an exemplary microscopic image of an example stainless steel substrate with an oxide layer disposed on the surface. The oxide layer includes a layered double hydroxide structure. Layered double hydroxides (LDHs) are ionic lamellar compounds having positively charged layers and an interlayer region with charge-compensating anions. Layered double hydroxides generally include mixed metals (e.g., nickel and/or iron) and hydroxide molecules separated by exchangeable anions. In some examples, the oxide layer can include a porous first layer and a second layer disposed over the porous first layer, the second layer including spheroidal structures deposited on the surface. The first layer can include an iron-nickel hydroxide layer and the spheroidal structures can include an iron-rich oxide material.

FIG. 3B illustrates a cross-sectional side view of a stainless steel surface 300, according to one exemplary embodiment. As illustrated, the stainless steel surface 300 includes a stainless steel substrate 302 and an oxide layer 304. In some examples, the oxide layer 304 can include a thickness greater than about 100 nm. In some examples, the oxide layer 304 can be about 125 nm in thickness or greater, about 150 nm in thickness or greater, about 175 nm in thickness or greater, about 200 nm in thickness or greater, about 225 nm in thickness or greater, about 250 nm in thickness or greater, or in thickness ranges of about 100 nm to about 150 nm, about 150 nm to about 200 nm, about 200 nm to about 250 nm, or about 250 nm to about 300 nm.

In some examples, the stainless steel surface 300 includes a layered double hydroxide. In some examples, the oxide layer 304 can include a microstructure 306 having a spheroidal structure 308. The spheroidal structure 308 can include a layered double hydroxide. In some examples, the oxide layer 304 can include the iron rich spheroidal structure 308 precipitate deposited on a porous iron-nickel layer.

In some examples, the spheroidal structure 308 can include a diameter less than about 100 nm. The spheroidal structure 308 can be about 20 nm in diameter or greater, about 40 nm in diameter or greater, about 50 nm in diameter or greater, about 70 nm in diameter or greater, about 80 nm in diameter or greater, about 90 nm in diameter or greater, or in ranges of about 20 nm to about 100 nm, about 40 nm to about 80 nm, about 50 nm to about 100 nm, or about 60 nm to about 80 nm. In some embodiments, the spheroidal structure 308 can be at least partially embedded into the porous layer. In some embodiments, the oxide layer can include a porosity between about 30% and about 80%. In some examples, the oxide layer can include a porosity of about 50%. In some embodiments, the porosity of the oxide layer can be 30% or greater, such as about 40% or greater, about 50% or greater, about 60% or greater, about 65% or greater, about 70% or greater, or in ranges of about 30% to about 40%, about 40% to about 50%, about 50% to about 60%, about 60% to about 70%, or about 70% to about 80%. In some embodiments, the oxide layer (e.g. oxide layer 304) can include a porous structure wherein a pore of the porous structure includes a diameter from about 20 to about 50 nm. In some examples, the porosity of an oxide layer can be adjusted according to the method of forming a layered double hydroxide film layer on the stainless steel substrate 302.

In some embodiments, the oxide layer 304 can include a first layer including an iron-nickel hydroxide layer. The first layer can include a well-adhered layer having a thickness between about 80 nm and about 150 nm. In some embodiments, the first layer can be about 80nm in thickness or greater, about 100 nm in thickness or greater, about 125 nm in thickness or greater, or in thickness ranges of about 80 nm to about 100 nm, about 100 nm to about 120 nm, about 120 nm to about 140 nm, or about 130 nm to about 150 nm. The oxide layer can further include a second layer that includes the iron-rich oxide disposed over the first layer, the second layer having spheroidal structures 308 having the diameter between about 20 nm and about 100 nm. The total thickness of the oxide layer 304 can be greater than about 100 nm and between about 100 nm and about 300 nm.

In some examples, the oxide layer 304 can include a high surface roughness. The surface roughness of the oxide layer can improve bonding at a stainless steel-polymer interface, where the polymer can extend into the oxide layer to form a high bond strength. In some examples, the oxide layer can include a surface roughness of between about 500 nm and about 1000 nm Sz. For this disclosure, Sz is defined as the sum of the largest peak height value and the largest pit depth value within the defined area. In other words, Sz is defined as the maximum peak height plus the maximum pit height.

The surface roughness can be about 500 nm Sz or greater, about 600 nm Sz or greater, about 700 nm Sz or greater, about 800 nm Sz or greater, about 900 nm Sz or greater or in ranges of about 500 nm Sz to about 600 nm Sz, about 600 nm Sz to about 700 nm Sz, about 700 nm Sz to about 800 nm Sz, about 800 nm Sz to about 900 nm Sz, or about 900 nm Sz to about 1000 nm Sz. In some examples, the surface can include a jagged peak and valley texture. The spheroidal structures 308 can be disposed in the valleys, connected to the peaks, or partially embedded in the porous layer portion of the oxide layer 304.

As explained below, the porous structure of the oxide layer 304 created by at least the porous iron-nickel layer and the layered double hydroxide microstructures 306 can create an interlocking structure with a non-metal material (e.g. polymer) when the non-metal material flows into the porous structure and is allowed to harden and transform from a melted state into a solid state.

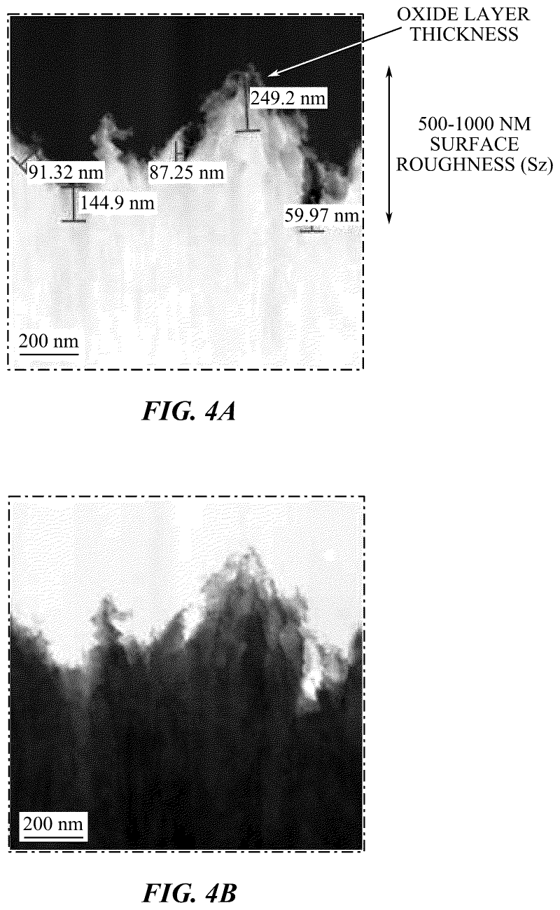

FIGS. 4A-4D illustrate exemplary microscopic images of an example stainless steel surface with a layered double hydroxide similar to that illustrated in FIGS. 3A-3B, including a stainless steel substrate 302 and an oxide layer 304 having a layered double hydroxide as a spheroidal structure 308 extending from the oxide layer 304, in accordance with some embodiments. FIGS. 4A-4C illustrate a cross-sectional view, where the oxide layer exhibits the peaks and valleys formed by the etching methods described below. As shown in FIGS. 4A-4D, jagged peaks and valleys are shown extending from the oxide layer and provide different angles and features on the stainless steel substrate. The terminal ends of the peaks have respective relative distances between them, defining crevices that improve stainless steel-polymer interface bonding. As shown in FIGS. 4C-4D, in some embodiments, the oxide layer (e.g. oxide layer 304) can include a porous structure wherein a pore of the porous structure includes a diameter from about 20 to about 80 nm. In some examples, the porosity of an oxide layer can be adjusted according to the method of forming a layered double hydroxide film layer on the stainless steel surface.

FIG. 5 illustrates a method 500 for forming a layered double hydroxide oxide layer on a stainless steel surface, according to some embodiments. As illustrated in FIG. 5, the method 500 can begin at block 502, where a stainless steel substrate can be etched to provide a roughening effect. In some examples, prior to roughening the surface of the stainless steel, the substrate can be degreased and rinsed. After rinsing, the stainless steel surface can be dried in preparation for etching. The etched surface can be beneficial in providing a roughed external surface of the stainless steel substrate that can promote growth of the oxide layer at the roughened regions. In some examples, the etching process can contribute up to about 15% bond strength between the oxide layer and the non-metal material. In other embodiments, the etching process can be omitted and/or replaced with other physical or chemical roughening pre-treatments.

At block 504, in some examples, the external surface of the substrate can be cleaned to remove any liquid or contaminants that may be present to further promote formation of an oxide layer over the stainless steel substrate. For example, the external surface of the stainless steel substrate can be cleaned and rinsed with tap water or deionized water in order to remove any remnants of the etching process. The stainless steel substrate surface can then be immersed in a caustic solution. In some examples, the caustic solution can include at least one of sodium hydroxide or potassium hydroxide. The solution can include between about 1 molar and about 10 molar sodium hydroxide or potassium hydroxide. In some examples, the caustic solution can include a pH from about 12 to about 14 and a temperature from about 50° C. to about 90° C., in some examples. The caustic solution oxidizes the stainless steel, which generates a porous and generally well-adhered iron-nickel hydroxide layer.

At block 506, the stainless steel surface can be etched while immersed in the hydroxide. In some examples, a cathodic potential can be applied to the stainless steel substrate to promote oxide growth. In some examples, a graphite anode can be utilized. However, the anode materials can include a stainless steel or any suitable anode material. In an example, etching the stainless steel substrate surface can include applying a voltage between about 2V and about 5V, or a pulsed or constant applied current density from about 8 to about 12 ampere per square decimeter (ASD). The potential can either be a pulsed or a constant applied potential. In some examples, the pulsed potential can include a pulse rate of between about 1 minute and about 4 minutes energized and about 1 minute and about 4 minutes de-energized, the pulse repeated between about 2 and about 20 times. In some examples, a ratio between the anode and the stainless steel substrate is between about 2:1 and about 10:1. In some examples, a ratio between the anode and the stainless steel substrate is about 5:1.

In some examples, the layered double hydroxide simultaneously attaches the oxide as it is formed, etching and roughening the oxide layer to form a fine-scale roughness and porosity that includes the layered double hydroxide spheroidal structure. The porosity enhances the adhesion of injection-molded polymers to the oxide surface.

In some examples, the stainless steel surface can be rinsed and dried. The external surface of the stainless steel substrate can be cleaned to remove any liquid or contaminants that may be present to improve bond strength between the oxide layer and the non-metal material (e.g. polymer).

In some examples, the treated stainless steel surface can then form a stainless steel-polymer interface. In some examples, the interface can include an oxide layer on a stainless steel substrate and a polymer, wherein the polymer permeates the oxide layer and forms a bond having a bond strength of about 25 MPa or greater. The stainless steel-polymer interface can include an injection molded polymer. In an example, a structural polymer such as glass-filled ABS can be injection molded with a resulting bond strength of about 32 MPa. As discussed above, with reference to FIG. 3B, after forming the oxide layer including the layered double hydroxide, a metal oxide layer can include pores that can be filled with a non-metal material. For example, the non-metal material can refer to a polymer material, such as polyethylene terephthalate (“PET”), polyaryletherketone (“PAEK”), polyether ether ketone (“PEEK”), an injection molded glass-filled PBT resin, a polyamide, and/or an epoxy that while in a melted or liquid state can be allowed to flow into the pores and/or the distances between the terminal ends of the plates of the oxide layer.

In some examples, the polymer can have any amount of viscosity or surface tension that is sufficient to attach to the oxide layer. In some examples, the stainless steel-polymer interface includes a polymer having a viscosity from about from about 800 Pa·s to about 200 Pa·s at about 5000 1/sec measurements. In some embodiments, the polymer viscosity can be about 500 Pa·s. In some embodiments, the polymer viscosity can be about 200 Pa·s or greater, such as about 300 Pa·s or greater, about 400 P·s or greater, about 500 Pa·s or greater, about 600 Pa·s or greater, about 700 Pa·s or greater, or in ranges of about 200 Pa·s to about 300 P·s, about 300 P·s to about 400 P·s, about 400 Pa·s to about 500 Pa·s, about 500 Pa·s to about 600 P·s or about 700 Pa·s to about 800 Pa·s. When the polymer material flows around the spheroidal structures and into the porous oxide structure, the polymer can penetrate past the double layer hydroxide and fill the voids within the oxide structure. After flowing into the porous oxide, the polymer can be allowed to harden. Thereafter, the polymer can transition from the liquid state into a solid state. Upon changing into the solid state, the polymer can be physically attached and bonded to the oxide layer.

In some examples, the polymer can include at least one of an injection molded glass-filled PBT resin, a polyamide, and/or an epoxy. In some examples, the oxide layer and the polymer form a stainless steel-polymer bond exhibiting a bond strength of about 25 MPa or greater. Generally, any failure in pull testing include cohesive failures within the glass-reinforced structural polymer, not adhesive failures between the polymer and the oxide layer or between the stainless steel substrate and the oxide layer.

FIG. 6A illustrates a diagram of a stainless steel-polymer interface and a configuration that can be used to test the bond strength of the interface, in accordance with some embodiments. In some examples, a stainless steel-polymer interface can include an oxide layer on a stainless steel substrate 602 and a polymer 604. The polymer can permeate the oxide layer and form a bond exhibiting a bond strength of about 25 MPa or greater. The bond strength can be determined by a bar pull test, where the polymer is pulled apart from the stainless steel substrate and the force at yield is recorded. In FIG. 6A, the polymer 604 is bonded to an oxide layer disposed on the stainless steel substrate 602. The polymer can be disposed between a first stainless steel substrate and a second stainless steel substrate, and the first and second substrates can pulled apart after the polymer has cured until the bond yields. As noted, the penetration of the polymer into the oxide layer shows strong bonding.

FIG. 6B illustrates a graph indicating a relationship of pull strength as a function of the type of processing of a stainless steel substrate compared to a relationship of pull strength as a function of the type of processing. The strength of the stainless steel-polymer bond is much higher after the stainless steel has been etched. In some examples the oxide layer can include a layered double hydroxide. The bond strength can be between about 28 MPa and about 35 MPa. In other words, the maximum pull strength can be between about 32 MPa and about 35 MPa.

In the exemplary trials, metal parts from different processes were attached at a 7 mm by 7 mm surface to a non-metal layer and were individually tested for pull strength. The non-metal layer included an injection molded Polybutylene Terephthalate (PBT) surface. The different metal parts included a stainless steel part that was not etched and a stainless steel part that had been etched according to the method described above in reference to FIG. 5. In the exemplary trials, the non-etched stainless steel part exhibited a pull strength of less than 5 MPa. The etched stainless steel exhibited a pull strength between about 32 MPa and about 35 MPa.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An oxide layer on a stainless steel substrate comprising a layered double hydroxide;
wherein the oxide layer comprises an iron-rich precipitate deposited on a porous iron-nickel layer.

2. The oxide layer of claim 1, wherein the oxide layer comprises a surface roughness of between about 500 nm and about 1000 nm Sz.

3. The oxide layer of claim 1, wherein the oxide layer comprises a thickness of about 100 nm to about 300 nm.

4. The oxide layer of claim 1, wherein the oxide layer comprises a porosity between about 30% and about 80%.

5. The oxide layer of claim 1, wherein the iron-rich precipitate comprises a microstructure including a spheroidal structure having a diameter between about 20 nm and about 100 nm.

6. The oxide layer of claim 1, wherein the oxide layer comprises a first layer including an iron-nickel hydroxide layer having a thickness between about 80 nm and about 150 nm; and
further comprising a second layer comprising an iron-rich oxide disposed over the first layer, the second layer comprising spheroidal structures having a diameter between about 20 nm and about 100 nm.

7. The oxide layer of claim 1, wherein the oxide layer further comprises a porous structure defining a pore having a diameter between about 20 nm and about 50 nm.

8. A stainless steel-polymer interface, comprising:
an oxide layer on a stainless steel substrate; and
a polymer extended into the oxide layer;
wherein the polymer extended into the oxide layer forms a bond comprising a bond strength of about 25 MPa or greater.

9. The stainless steel-polymer interface of claim 8, wherein the oxide layer comprises a layered double hydroxide.

10. The stainless steel-polymer interface of claim 8, wherein the polymer comprises a glass-filled PBT resin, a polyamide, or an epoxy.

11. The stainless steel-polymer interface of claim 8, wherein the oxide layer comprises a surface roughness greater than about 500 nm Sz.

12. The stainless steel-polymer interface of claim 8, the oxide layer comprising an iron-rich precipitate deposited on a porous iron-nickel layer.

13. The stainless steel-polymer interface of claim 8, wherein the polymer comprises an injection-molded polymer.

14. The stainless steel-polymer interface of claim 8, wherein the polymer comprises a dynamic viscosity from about 800 Pa·s to about 200 Pa·s.

15. A method of forming an oxide layer on a stainless steel substrate comprising:
etching the stainless steel substrate by immersing the substrate in a caustic solution; and
applying a cathodic potential between the stainless steel substrate and an anode.

16. The method of claim 15, wherein the caustic solution comprises a solution between about 1 molar and about 10 molar sodium hydroxide or potassium hydroxide.

17. The method of claim 15, wherein the cathodic potential comprises a pulsed potential comprising a voltage between about 2V and about 5V and a pulse rate of between about 1 minute and about 4 minutes energized, and about 1 minute and about 4 minutes de-energized, the pulse repeated between about 2 and about 20 times.

18. The method of claim 15, wherein the caustic solution is between about 50° C. and about 90° C.

19. The method of claim 15, wherein a ratio between the anode and the stainless steel substrate is between about 2:1 and about 10:1.

20. The method of claim 15, wherein the oxide layer comprises a surface roughness between about 500 nm and about 1000 nm Sz.
